(19) United States
(12) Patent Application Publication
(10) Pub. No.: US 2025/0384588 A1
(43) Pub. Date: Dec. 18, 2025

(54) JOINT IMAGE AND VIDEO TOKENIZATION WITH CAUSAL VARIATIONAL AUTOENCODER

(71) Applicant: NVIDIA Corp., Santa Clara, CA (US)

(72) Inventors: Fitsum Reda, Santa Clara, CA (US); Dawit Mureja Argaw, Daejeon (KR); Ming-Yu Liu, San Jose, CA (US); Qinsheng Zhang, Santa Clara, CA (US)

(73) Assignee: NVIDIA Corp., Santa Clara, CA (US)

(21) Appl. No.: 19/232,680

(22) Filed: Jun. 9, 2025

Related U.S. Application Data
(60) Provisional application No. 63/660,091, filed on Jun. 14, 2024.

(51) Int. Cl. G06T 9/00; G06N 3/0455; G06N 3/0464

(52) U.S. Cl. CPC G06T 9/002; G06N 3/0455; G06N 3/0464

(57) ABSTRACT

Video compression systems based on a variational autoencoder, the variational autoencoder including an encoder and a decoder coupled via a latent space embedding component, the encoder configured to transform an input video into a feature maps of the input video at different feature resolution scales, the latent space embedding component configured to transform the feature maps into a latent space parameter distribution, and the decoder configured to sample the latent space parameter distribution to generate a compressed version of the input video.

### CROSS-REFERENCE TO RELATED APPLICATIONS

This application claims priority and benefit under 35 U.S.C. 119(e) to U.S. Application No. 63/660,091, “Joint Image and Video Compression with Causal VAE”, filed on Jun. 14, 2024, the contents of which are incorporated herein by reference in their entirety.

### BACKGROUND

Generative modeling by artificial intelligence models has recently undergone significant advancements in image and video synthesis. However, video generation by artificial intelligence models remains a challenge, due to the inherently complex and high-dimensional nature of video.

Some conventional mechanisms for video generation by artificial intelligence models utilize low-dimensional latent spaces derived from pre-trained image autoencoders. These mechanisms due not efficiently utilize temporal redundancy in videos and often lead to temporally incoherent decoding.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a variational autoencoder in one embodiment.

FIG. 2 depicts a variational autoencoder utilizing shared encoder weights across different feature scales.

FIG. 3A depicts a causal three-dimensional (3D) residual block in one embodiment.

FIG. 3B depicts a spatio-temporal attention block in one embodiment.

FIG. 3C depicts a spatio-temporal downsampling block in one embodiment.

FIG. 3D depicts a spatio-temporal upsampling block in one embodiment.

FIG. 4A-FIG. 4C depict examples of causal 3D convolution applied to a temporally- ordered sequence of video frames.

FIG. 5 depicts a parallel processing unit in accordance with one embodiment.

FIG. 6 depicts a general processing cluster in accordance with one embodiment.

FIG. 7 depicts a memory partition unit in accordance with one embodiment.

FIG. 8 depicts a streaming multiprocessor in accordance with one embodiment.

FIG. 9 depicts a processing system in accordance with one embodiment.

FIG. 10 depicts an exemplary processing system in accordance with another embodiment.

### DETAILED DESCRIPTION

Disclosed herein are embodiments of video compression systems that reduce the dimensionality of visual content both spatially and in time (temporally). The disclosed models are based on variational autoencoders. The disclosed variational autoencoder embodiments may employ causal three-dimensional (3D) convolution to process images and videos jointly.

A variational autoencoder is a type of generative model that integrates deep learning and Bayesian inference mechanisms to generate outputs that are similar to an input along some feature dimensions.

A common variational autoencoder structure comprises an encoder and a decoder coupled via a latent space. The encoder transforms the input into a distribution in the latent space, typically parameterized by a mean μ and a standard deviation σ. The variational autoencoder may utilize one or more neural networks to generate estimates of these parameters.

Instead of encoding the input to a fixed point in the latent space, the variational autoencoder may encode the input to a probability distribution. This enables the sampling of latent variables, facilitating the generation of outputs that are variations of the input. The latent space is a multidimensional structure where inputs are encoded and stored before being transformed into outputs. The latent space structure of a variational autoencoder may encode features and patterns of the input by applying weights and activation values of a neural network, often in a reduced dimensionality and complexity from the input feature space.

The decoder component of a variational autoencoder maps points from the latent space back to the input feature space.

A variational autoencoder may be trained with a loss function that combines reconstruction loss and regularization loss. The reconstruction loss measures how accurately the decoder reconstructed the inputs from the latent space. The regularization loss helps ensure that the latent space distributions are close to Gaussian distributions, facilitating smooth sampling. The combined loss metric may encourage the variational autoencoder model to learn a meaningful and smooth latent space from which new, realistic output samples may be generated.

Variational autoencoders may be utilized for applications including dimensionality reduction of complex content types. Variational autoencoders may reduce the dimensions of such content while preserving important features, making them useful for data compression. Variational autoencoders may also be utilized to generate new samples that resemble but are not identical to the training data utilized to configure artificial intelligence models.

Variational autoencoders may learn the normal distribution of training sets, so as to identify or predict anomalies or outliers. They may learn meaningful and interpretable features of their inputs, aiding in tasks like classification and clustering, and may provide a probabilistic framework for inference useful in uncertain or stochastic environments.

The disclosed variational autoencoder mechanisms utilize a scale-agnostic encoder component that preserves video fidelity, spatial-temporal downsampling and upsampling blocks for long-sequence modeling, and flow regularization loss for motion decoding. The disclosed mechanisms may also be utilized to train a variational autoencoder for video generation.

The disclosed variational autoencoder models operate in a continuous-time space that reduces the dimensionality of visual content into a learned latent and maps the generated latent back to pixel space.

The disclosed variational autoencoder mechanisms may comprise a deep learning model comprising temporally-causal 3D convolution layers interleaved with self-attention layers. Image and video compression may be integrated within a single such variational autoencoder model.

The variational autoencoder may be further configured for spatial-temporal compression with a weight-shared encoder that learns (is configured via training) to aggregate features across different scales of the input video. Sharing encoder weights and aggregating features from different depths of a feature pyramid may increase the number of pixels available to effectively encode large motions. Configured in this manner, the variational autoencoder model (including the decoder component) may demonstrate improved decoding of large motions in videos over conventional mechanisms.

Some conventional mechanisms employ non-learnable kernels for downsampling and upsampling followed by a convolutional layer i.e. average pooling for downsampling and nearest interpolation for upsampling. However, this mechanism often suffers from potential loss of high frequency spatial-temporal features, as non-learnable kernels may treat all features within the pooling (interpolation) window equally. Utilizing learnable kernels may mitigate this limitation but may overfit to the temporal sequence length the system has been trained on, with performance notably dropping when inference is carried on on different sequence lengths than those trained on, thereby limiting the model's scalability to arbitrary-length videos.

The disclosed variational autoencoder embodiments may be implemented as dual-path deep learning neural networks utilizing both learnable and non-learnable kernels. The variational autoencoder may encode and decode arbitrary-length videos sampled at varying lengths. The encoded latent representation in the variational autoencoder may faithfully preserve the motion dynamics by applying a flow regularization loss function during training. The loss may be incorporated by optimizing the mean-squared error between the optical flows of the input video frames and their corresponding optical flows in the decoded video frames. Embodiments of a model to compute the optical flows are also disclosed.

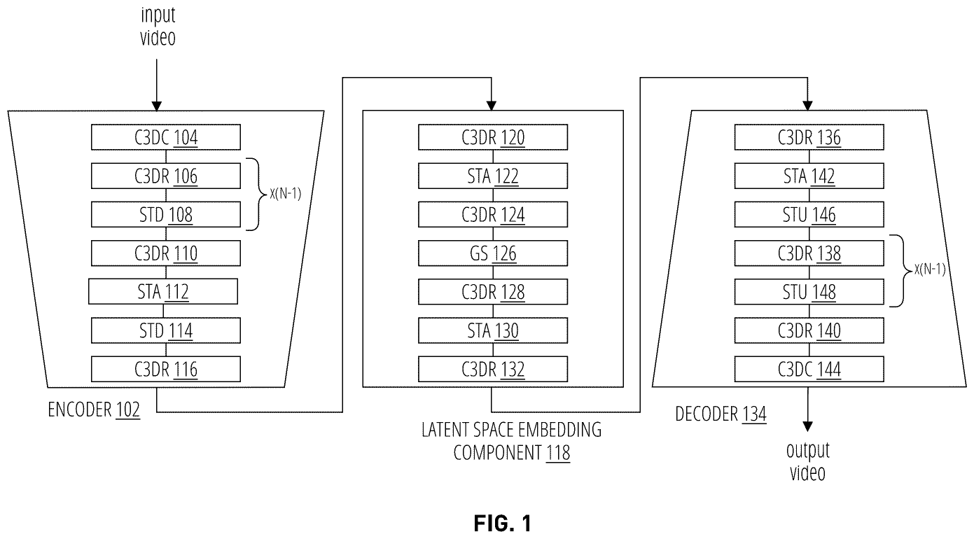

FIG. 1 depicts a variational autoencoder in one embodiment. The variational autoencoder comprises an encoder 102 comprising a causal 3D convolution block 104, a causal 3D residual block 106, a spatio-temporal downsampling block 108, a causal 3D residual block 110, a spatio-temporal attention block 112, a spatio-temporal downsampling block 114, and a causal 3D residual block 116.

The variational autoencoder further comprises a latent space embedding component 118 comprising a causal 3D residual block 120, a spatio-temporal attention block 122, a causal 3D residual block 124, a Gaussian sampling block 126, a causal 3D residual block 128, a spatio-temporal attention block 130, and a causal 3D residual block 132.

The variational autoencoder further comprises a decoder 134 comprising a causal 3D residual block 136, a causal 3D residual block 138, a causal 3D residual block 140, a spatio-temporal attention block 142, a causal 3D convolution block 144, a spatio-temporal upsampling block 146, and a spatio-temporal upsampling block 148.

The variational autoencoder may be utilized to reduce the dimensionality of an input video while maintaining the video's fidelity. Maintaining video fidelity has proven challenging to conventional variational autoencoders when the video comprises small and fast moving objects. Small objects with large motions may vanish at the deeper levels of the encoder's feature pyramid. There may be significantly fewer pixels at the deeper levels of the feature pyramid to preserve large motion information.

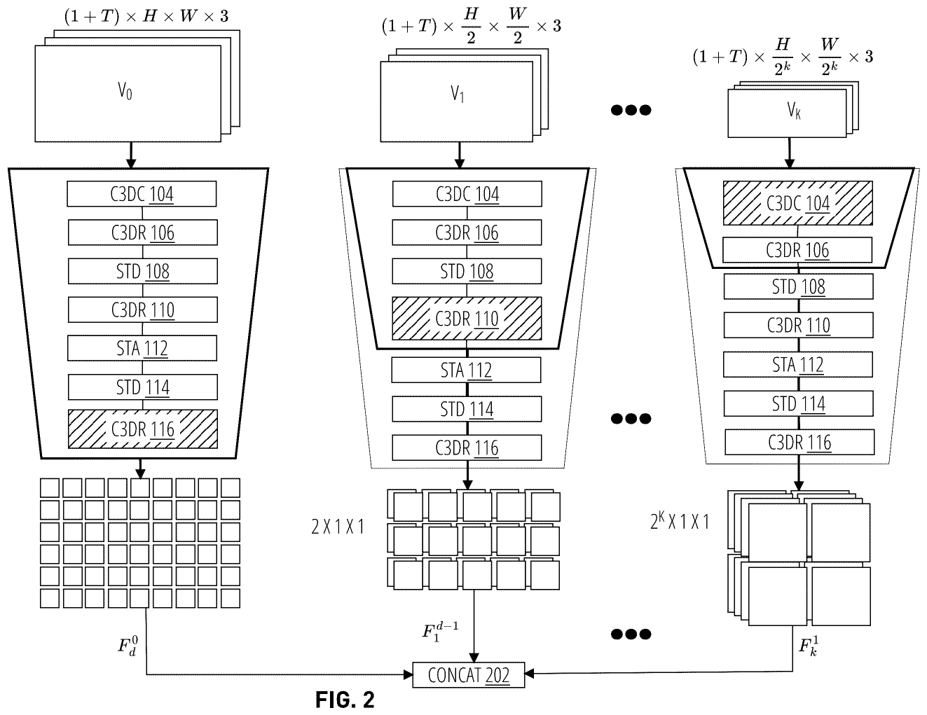

To overcome these challenges, the disclosed variational autoencoders may utilize shared encoder weights across different feature scales as depicted in FIG. 2. Given a video V₀ of dimensionality (1+T)×H×W×3, a pyramid {V₀, V₁, . . . , Vₖ} is generated by successively resizing the input video, where a given pyramid level Vₖ has a dimensionality of

$$( 1 + T ) \times \frac{H}{{2}^{k}} \times \frac{W}{{2}^{k}} \times 3.$$

Feature pyramids Fₖⁱ are generated for each level of the input pyramid to the encoder 102:

$$( {\{ {F}_{0}^{i} \}}_{i = 1}^{d} , {\{ {F}_{1}^{i} \}}_{i = 1}^{d} , … , {\{ {F}_{k}^{i} \}}_{i = 1}^{d} ) = encode ( {V}_{0} , {V}_{1} , … , {V}_{k} ) \qquad Equation 1$$

$$F = concatenate ( {F}_{0}^{d} , {F}_{1}^{d - 1} , … , {F}_{k}^{1} ) \qquad Equation 2$$

where d denotes the maximum level depth of the feature pyramid.

A scale-agnostic feature map is constructed by channel-wise concatenating (concatenator 202) features from different depths of the input pyramid comprising the same spatial dimension, per Equation 2. Temporal average pooling may be utilized to align the dimensions of the features

$${F}_{1}^{d - 1} , … , {F}_{k}^{1}$$

to

$${F}_{0}^{d}$$

before concatenation.

By utilizing the same encoder weights to process each level the input pyramid, large motions at the deeper depths of the input video V₀ may align with smaller motions at shallower depths of Vₖ. Aggregating features from different depths of the feature pyramid effectively boosts the number of pixels available to accurately encode large motions.

The output of the encoder 102 is applied to the latent space embedding component 118 where scale-agnostic features are projected into a latent representation with a reduced channel size. The latent space embedding component 118 is configured via training to sample from the learned distribution of the encoded latent space and to generate a latent representation v with reduced spatial and temporal dimensionality relative to V₀. An isotropic Gaussian distribution may be utilized to parameterize the mean u and standard deviation o of the encoded latent variables, from which samples are obtained by the sampling layer (Gaussian sampling block 126).

The decoder 134 transforms the sampled latent values back to the input video.

The variational autoencoder may be trained (configured) using various loss functions. A reconstruction loss L_{R} may be calculated as the L1 loss between the input video V₀ and the decoded video \hat{V}:

$${L}_{R} = {\sum }_{i = 1}^{1 + T} \vert {V}_{i} - {\hat{V}}_{i} \vert \qquad Equation 3$$

where Vᵢ denotes the i^{th} frame index in the input video.

A perceptual similarity L_{P} between each input video frame and the corresponding reconstructed frame may be determined using frame-wise LPIPS loss.

LPIPS (Learned Perceptual Image Patch Similarity) loss calculates the perceptual similarity between two images by comparing their feature representations within a deep neural network. Instead of directly comparing pixel values, LPIPS focuses on how the network's internal representations of the images differ.

The LPIPS loss determination may utilize a pre-trained deep convolutional neural network (like VGGNet) to extract feature maps from both the original and predicted (or generated) images.

These feature maps are then compared, for example using a Euclidean distance or cosine similarity measure. This comparison is performed at different layers of the network, capturing features at varying levels of abstraction.

The differences between the feature representations are aggregated to produce a single loss value Lₚ, indicating the perceptual similarity between the two images. A lower LPIPS score indicates greater perceptual similarity, meaning the images look more similar to a human observer.

In essence, LPIPS leverages the deep network's learned ability to represent images in a perceptual space, allowing it to quantify the similarity between images based on how they are perceived by the network, which often aligns with human perception.

To mitigate arbitrary high-variance in the encoded latent spaces, a K_{L} regularization loss L_{KL} may be applied by guiding the learned latent distribution towards a standard normal. Regularization loss refers to the adjustments applied to the model's weights during training to prevent overfitting. Regularization loss may be calculated based on the Lₖ norm of the weight vectors, where k determines the specific type of regularization (e.g., k=1 for L1 loss, k=2 for L2 loss).

To help ensure that the decoded video accurately preserves the motion dynamics of the input video, a flow regularization loss L_{f} may also be utilized. The loss L_{f} may be determined as the mean-squared error between the optical flows of the input video frames and the corresponding optical flows in the decoded video frames. To compute the optical flows, a pretrained RAFT model may be applied in a bidirectional mode, as expressed in Equation 4, to help ensure robust motion supervision.

$${L}_{f} = {\sum }_{i = 1}^{T} [ {\vert {f}_{i \to i + 1} - {\hat{f}}_{i \to i + 1} \vert}_{2}^{2} + {\vert {f}_{i + 1 \to i} - {\hat{f}}_{i + 1 \to i} \vert}_{2}^{2} ] \qquad Equation 4$$

where f_{i→i+1} represents the optical flow between \hat{V}ᵢ and \hat{V}ᵢ₊₁ frames in the decoded video. A model trained with flow regularization may decode temporally-smoother motion compared to a model trained without it. Th L_{f} loss may also improve capture of motion at higher temporal compression rates.

RAFT (Retrieval-Augmented Fine-Tuning) is a model training mechanism that combines features of both Retrieval-Augmented Generation (RAG) and fine-tuning. RAFT combines fine-tuning with a retrieval component. During training, the model is exposed to both domain-specific data and a retrieval mechanism that fetches relevant information from external sources. This enables the model to learn not only the specifics of the domain but also how to effectively utilize external knowledge to infer results.

The total loss for training the variational autoencoder may be expressed as a sum of the individual loss components:

$${L}_{vae} = {L}_{R} + {L}_{P} + {α}_{1} {L}_{f} + {α}_{2} {L}_{KL} \qquad Equation 5$$

where α₁ and α₂ denote empirically-determined weights for the flow loss L_{f} and regularization loss L_{KL}, respectively.

Adversarial training may also be utilized to enhance the quality of the decoded video. An optimized 3D convolution-based PatchGAN discriminator may be utilized to distinguish between original videos and those generated by the variational autoencoder.

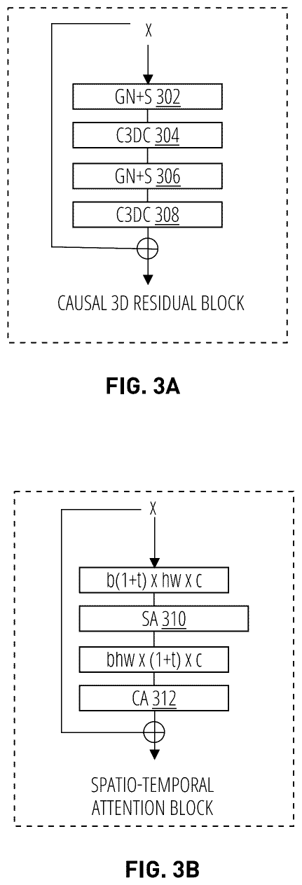

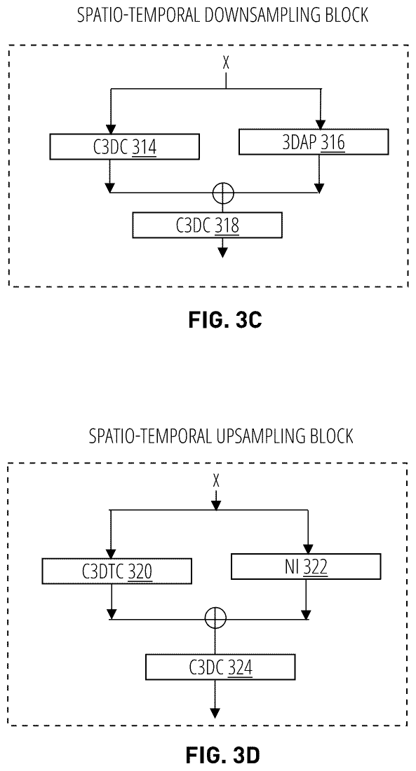

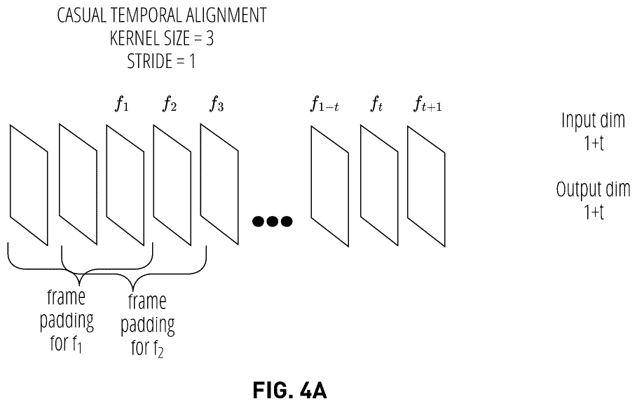

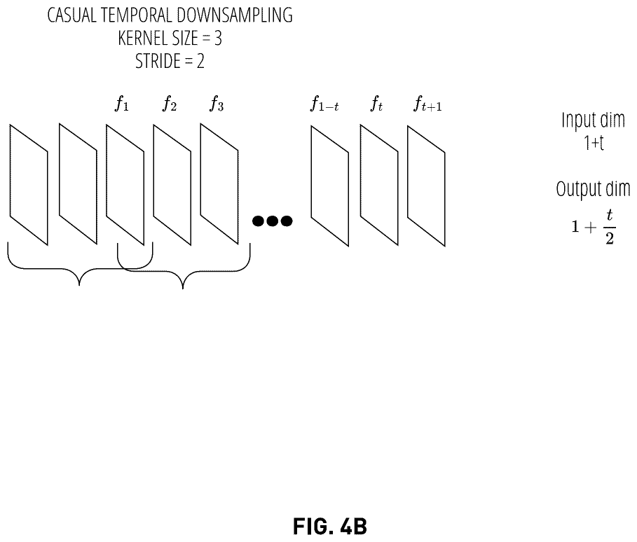

FIG. 3A depicts a causal 3D residual block in one embodiment. The causal 3D residual block comprises group normalization and Swish activation layer(s) 302, causal 3D convolution layer(s) 304, group normalization and Swish activation layer(s) 306, and causal 3D convolution layer(s) 308.

The causal 3D convolution layer(s) 304, 308 perform convolutions over three-dimensional data, e.g., video sequences or volumetric data. In a causal setup, the convolutions are restricted to only use past and present inputs (e.g., video frames) from the input sequence, not ‘future’ inputs (frames occurring after the current one in the video's temporal sequence order).

In some embodiments, batch normalization may be applied after convolution to normalize the inputs per-batch. This may facilitate stabilization of the learning process and reduce the number of training epochs required.

The group normalization and Swish activation layer(s) 302, 306 utilize group normalization. Unlike batch normalization, which normalizes input across an entire mini-batch, group normalization divides the channels of an input into groups and computes the normalization statistics for each group independently. This structure may demonstrate improved effectiveness in scenarios with small mini-batch sizes because the normalization is independent of the batch size. Group normalization may be particularly useful in tasks where batch normalization's performance is limited due to small batch sizes.

A non-linear activation function may be utilized to introduce non-linearity into the model incorporating the causal 3D residual blocks. The Swish operation is a non-linear activation function defined as Swish(x)=x×sigmoid(x), where

$$sigmoid ( x ) = \frac{1}{1 + {e}^{- x}} .$$

Swish is a smooth, non-monotonic activation function that may perform better than or comparably to ReLU (Rectified Linear Unit) in many deep learning tasks. Swish preserves small negative values in the inputs, which may be beneficial for gradient flow and, consequently, for the network's training process. The smooth nature of Swish may also facilitate optimization by providing more nuanced gradient information compared to piecewise linear functions like ReLU.

The causal 3D residual block may comprise a residual connection adding the input of the block to its output. This may facilitate learning of identity mappings by the model and mitigate vanishing gradient issues. In some embodiments, dropout may be applied to mitigate overfitting by randomly setting a portion of the activations to zero during training.

Some embodiments of the causal 3D residual blocks may utilize causal padding to help ensures that the temporal dimension is preserved, and only past information is used for prediction in the temporal aspect of the data.

The depicted causal 3D residual block is a residual network comprising two temporally causal 3D convolution layers, along with group normalization (GN) and Swish activation layers.

For a kernel size (kₜ, kₕ, h_{w}), the padding scheme in the temporal axis of a conventional (non-causal) 3D convolutional layer is to add

$$⌊ \frac{{k}_{t} - 1}{2} ⌋$$

frames from before and f

$$⌊ \frac{{k}_{t}}{2} ⌋$$

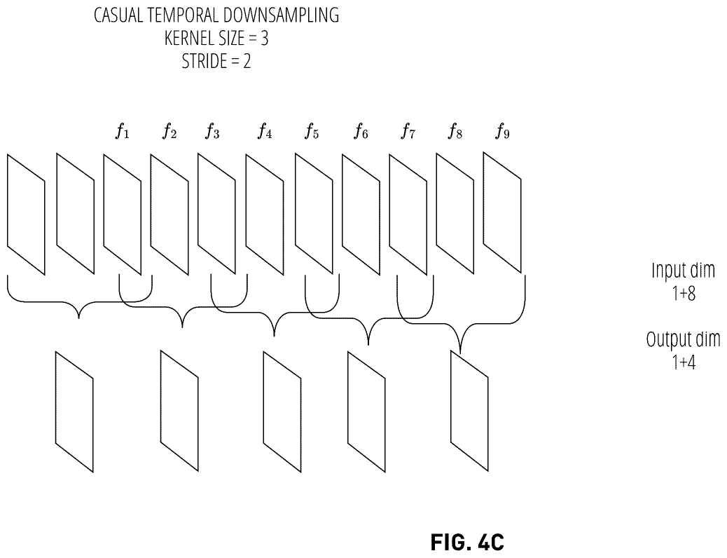

from after the input frames, respectively. The causal 3D convolution layers utilized by the disclosed mechanisms may pad with kₜ−1 frames from before the input frames and with no frames coming after, ensuring that the output from processing each frame causally relies solely on the preceding frames. See for example FIG. 4A-FIG. 4C. As a result, the first frame remains independent of the subsequent frames, enabling the disclosed mechanisms to compress single images as well.

FIG. 3B depicts a spatio-temporal attention block in one embodiment. The spatio-temporal attention block comprises a self-attention layer 310 and a causal attention layer 312.

A causal attention layer in a neural network, similar to a causal 3D convolution layer, is a mechanism configured to process input sequences such that each position in the sequence attends only to positions that come before it in the sequence, ensuring that the attention operation respects the temporal order of the sequence. This is useful in autoregressive models and for tasks that operate on sequential temporal inputs, where future inputs cannot be accurately applied to predict the current or past states. For example, keys, queries, and values may computed for each element in the sequence, with a mask applied to ensure that no inputs from the future are attended to at any position in the sequence.

The spatio-temporal attention block captures spatial and temporal dependencies within an input video using self-attention layer(s). Given a feature of size b×(1+t)×h×w×c, the spatial attention may be implemented by reshaping the feature to b(1+t)×hw×c and passing it to a single self-self-attention layer 310 followed by reshaping the input feature to bhw×(1+t)×c and applying it to a causal attention layer 312 in the temporal dimension. To address the computational complexity arising from merging spatial dimensions, the disclosed mechanisms may apply the spatio-temporal attention block only at the lower resolutions of the feature pyramid in the encoder (see FIG. 2).

Like the causal 3D residual block, the spatio-temporal attention block may comprise a residual connection adding the input of the block to its output.

FIG. 3C depicts a spatio-temporal downsampling block in one embodiment. The spatio-temporal downsampling block comprises a causal 3D convolution layer 314 and a 3D average pooling layer 316 the outputs of which are added to supply a causal 3D convolution layer 318.

The 3D average pooling layer 316 may operate a sliding a 3D window, or kernel, across the input data volume and compute the average value of the elements within each window. The stride of the layer determines the step size used to move the window across the input data. Padding may be configured to set how the boundaries of the input are handled (e.g., with zeros to maintain the same output dimensions). The output of the 3D average pooling layer 316 is a downsampled version of the input data, where the spatial resolution is reduced according to the kernel size, stride, and padding settings.

Given a feature volume x of dimensions b×(1+t)×h×w×c, where b denotes the batch size, the spatio-temporal downsampling block utilized in the disclosed mechanisms may reduce the spatial and temporal dimensions of x to b×(1+t/2)×h/2×w/2×c.

Conventional mechanisms may implement average pooling followed by a convolution layer. However, such approach is not optimal, particularly for higher compression rates, because average pooling treats all features within the pooling window equally, potentially resulting in the loss of high-frequency spatial or temporal information. Other conventional approaches may implement strided convolutions instead of average pooling to leverage trained convolution kernels.

A variational autoencoder trained with learnable downsampling kernels generally performs well but often fails to be temporally agnostic, i.e. it overfits to the specific video sequence lengths it is trained with and performance notably drops when inference is done by sampling the input video at different sequence lengths. This limits the adaptability of the model to longer (than trained on) sequence encoding and reduces the resistance of the latent space values to noise corruption.

To address these limitations, the disclosed mechanisms may utilize a temporally-agnostic (generalized to any sequence length) downsampling block. The spatio-temporal downsampling block 108 may comprise a dual-path utilizing both trainable and non-trainable kernels. The input feature x may be processed through a strided causal 3D convolution layer 314 and a 3D average pooling layer 316 concurrently, with the resulting outputs are combined via summation. A spatio-temporal downsampling block configured in this manner may effectively address the aforementioned limitations with improved performance.

The downsampling via average pooling mitigates the risk of the temporal receptive field overfitting to a specific sequence length while trainable kernels in the causal 3D convolution layers 314, 318 facilitate downsampling by selectively emphasizing or suppressing certain features based on their relevance.

FIG. 3D depicts a spatio-temporal upsampling block in one embodiment. The spatio-temporal upsampling block comprises a causal 3D transpose convolution layer 320 and an interpolation upsampling layer 322 configured in parallel, the outputs of which are added and applied to a causal 3D convolution layer 324.

The interpolation upsampling layer 322 increases the spatial dimensions of the input feature x by interpolating values of a higher-resolution output from neighboring original values of the input.

Given a feature volume x of size b×(1+t)×h×w×c, the spatio-temporal upsampling block increases the spatial and temporal dimensions of x to b×(1+2t)×2h×2w×c. Like the spatio-temporal downsampling block, spatio-temporal upsampling block may be configured as a dual-path module incorporating both trainable and non-trainable kernels. The causal 3D transpose convolution layer 320 may provide for trainable upsampling. To map 1+t frames to 1+2t frames, thereby enabling the application of the variational autoencoder to both images and videos, the first frame after the upsampling process may be discarded. A nearest-neighbor interpolation by the interpolation upsampling layer 322 in both spatial and temporal dimension may provide for non-learnable upsampling.

The variational autoencoder mechanisms disclosed herein may be implemented in and/or by computing devices utilizing one or more graphic processing unit (GPU) and/or general purpose data processor (e.g., a “central processing unit” i.e. CPU). A graphics processing unit may be a standalone chip or package, or may comprise graphics processing circuitry integrated with a central processing unit. Exemplary architectures will now be described that may be configured to implement the mechanisms disclosed herein, for example by configuring a memory 520 with machine-readable instructions that when applied to a parallel processing unit 502 and/or central processing unit 902 configure a computer system comprising those units to implement the disclosed variational autoencoder mechanisms.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

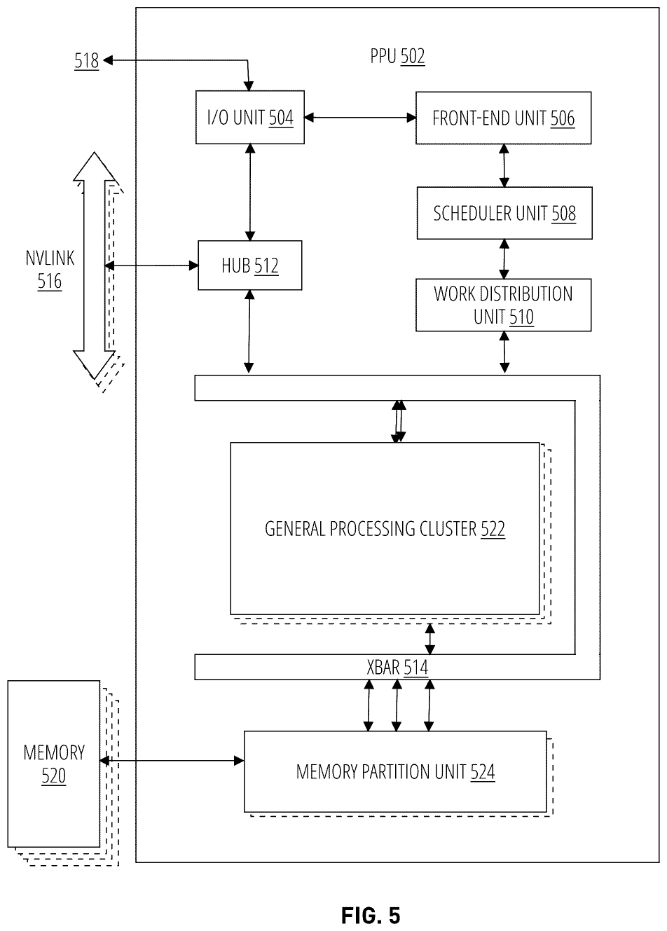

FIG. 5 depicts a parallel processing unit 502, in accordance with an embodiment. In an embodiment, the parallel processing unit 502 is a multi-threaded processor that is implemented on one or more integrated circuit devices. The parallel processing unit 502 is a latency hiding architecture designed to process many threads in parallel. A thread (e.g., a thread of execution) is an instantiation of a set of instructions configured to be executed by the parallel processing unit 502. In an embodiment, the parallel processing unit 502 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 502 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 502 modules may be configured to accelerate thousands of High Performance Computing (HPC), data center, and machine learning applications. The parallel processing unit 502 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the parallel processing unit 502 includes an I/O unit 504, a front-end unit 506, a scheduler unit 508, a work distribution unit 510, a hub 512, a crossbar 514, one or more general processing cluster 522 modules, and one or more memory partition unit 524 modules. The parallel processing unit 502 may be connected to a host processor or other parallel processing unit 502 modules via one or more high-speed NVLink 516 interconnects. The parallel processing unit 502 may be connected to a host processor or other peripheral devices via an interconnect 518. The parallel processing unit 502 may also be connected to a local memory comprising a number of memory 520 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 520 may comprise logic to configure the parallel processing unit 502 to carry out aspects of the techniques disclosed herein.

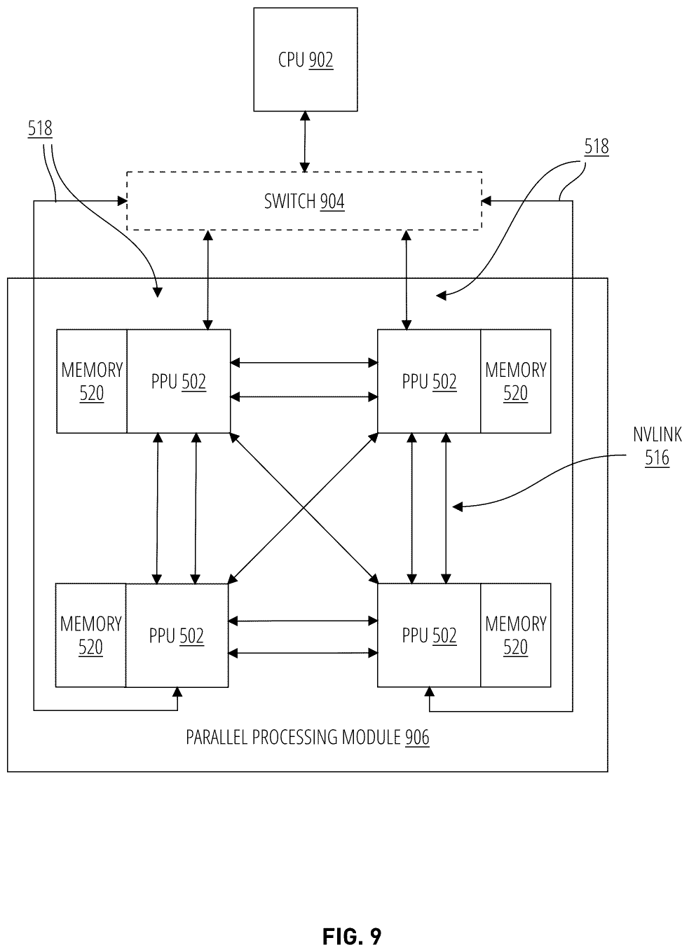

The NVLink 516 interconnect enables systems to scale and include one or more parallel processing unit 502 modules combined with one or more CPUs, supports cache coherence between the parallel processing unit 502 modules and CPUs, and CPU mastering. Data and/or commands may be transmitted by the NVLink 516 through the hub 512 to/from other units of the parallel processing unit 502 such as one or more copy engines, a video encoder, a video decoder, a power management unit, etc. (not explicitly shown). The NVLink 516 is described in more detail in conjunction with FIG. 9.

The I/O unit 504 is configured to transmit and receive communications (e.g., commands, data, etc.) from a host processor (not shown) over the interconnect 518. The I/O unit 504 may communicate with the host processor directly via the interconnect 518 or through one or more intermediate devices such as a memory bridge. In an embodiment, the I/O unit 504 may communicate with one or more other processors, such as one or more parallel processing unit 502 modules via the interconnect 518. In an embodiment, the I/O unit 504 implements a Peripheral Component Interconnect Express (PCIe) interface for communications over a PCIe bus and the interconnect 518 is a PCIe bus. In alternative embodiments, the I/O unit 504 may implement other types of well-known interfaces for communicating with external devices.

The I/O unit 504 decodes packets received via the interconnect 518. In an embodiment, the packets represent commands configured to cause the parallel processing unit 502 to perform various operations. The I/O unit 504 transmits the decoded commands to various other units of the parallel processing unit 502 as the commands may specify. For example, some commands may be transmitted to the front-end unit 506. Other commands may be transmitted to the hub 512 or other units of the parallel processing unit 502 such as one or more copy engines, a video encoder, a video decoder, a power management unit, etc. (not explicitly shown). In other words, the I/O unit 504 is configured to route communications between and among the various logical units of the parallel processing unit 502.

In an embodiment, a program executed by the host processor encodes a command stream in a buffer that provides workloads to the parallel processing unit 502 for processing. A workload may comprise several instructions and data to be processed by those instructions. The buffer is a region in a memory that is accessible (e.g., read/write) by both the host processor and the parallel processing unit 502. For example, the I/O unit 504 may be configured to access the buffer in a system memory connected to the interconnect 518 via memory requests transmitted over the interconnect 518. In an embodiment, the host processor writes the command stream to the buffer and then transmits a pointer to the start of the command stream to the parallel processing unit 502. The front-end unit 506 receives pointers to one or more command streams. The front-end unit 506 manages the one or more streams, reading commands from the streams and forwarding commands to the various units of the parallel processing unit 502.

The front-end unit 506 is coupled to a scheduler unit 508 that configures the various general processing cluster 522 modules to process tasks defined by the one or more streams. The scheduler unit 508 is configured to track state information related to the various tasks managed by the scheduler unit 508. The state may indicate which general processing cluster 522 a task is assigned to, whether the task is active or inactive, a priority level associated with the task, and so forth. The scheduler unit 508 manages the execution of a plurality of tasks on the one or more general processing cluster 522 modules.

The scheduler unit 508 is coupled to a work distribution unit 510 that is configured to dispatch tasks for execution on the general processing cluster 522 modules. The work distribution unit 510 may track a number of scheduled tasks received from the scheduler unit 508. In an embodiment, the work distribution unit 510 manages a pending task pool and an active task pool for each of the general processing cluster 522 modules. The pending task pool may comprise a number of slots (e.g., 32 slots) that contain tasks assigned to be processed by a particular general processing cluster 522. The active task pool may comprise a number of slots (e.g., 4 slots) for tasks that are actively being processed by the general processing cluster 522 modules. As a general processing cluster 522 finishes the execution of a task, that task is evicted from the active task pool for the general processing cluster 522 and one of the other tasks from the pending task pool is selected and scheduled for execution on the general processing cluster 522. If an active task has been idle on the general processing cluster 522, such as while waiting for a data dependency to be resolved, then the active task may be evicted from the general processing cluster 522 and returned to the pending task pool while another task in the pending task pool is selected and scheduled for execution on the general processing cluster 522.

The work distribution unit 510 communicates with the one or more general processing cluster 522 modules via crossbar 514. The crossbar 514 is an interconnect network that couples many of the units of the parallel processing unit 502 to other units of the parallel processing unit 502. For example, the crossbar 514 may be configured to couple the work distribution unit 510 to a particular general processing cluster 522. Although not shown explicitly, one or more other units of the parallel processing unit 502 may also be connected to the crossbar 514 via the hub 512.

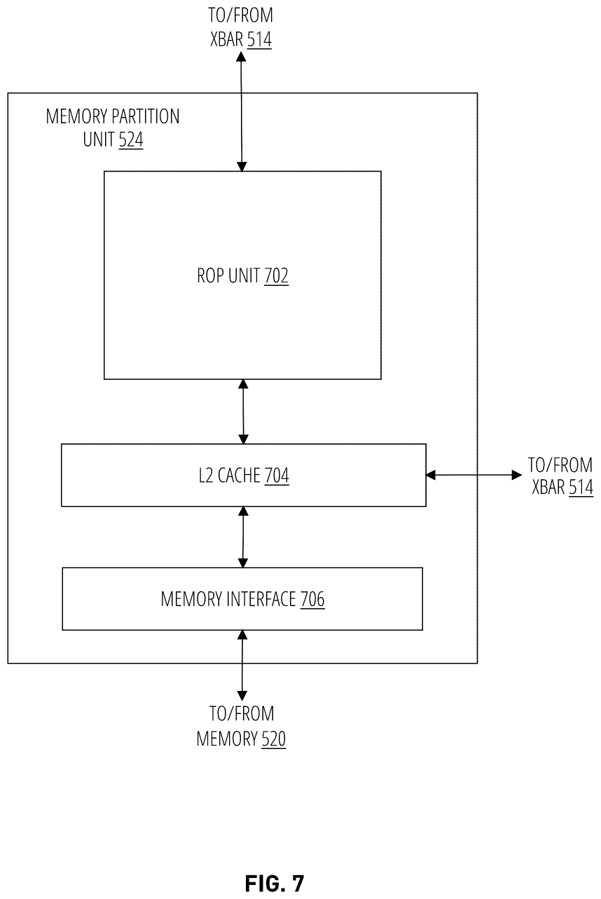

The tasks are managed by the scheduler unit 508 and dispatched to a general processing cluster 522 by the work distribution unit 510. The general processing cluster 522 is configured to process the task and generate results. The results may be consumed by other tasks within the general processing cluster 522, routed to a different general processing cluster 522 via the crossbar 514, or stored in the memory 520. The results can be written to the memory 520 via the memory partition unit 524 modules, which implement a memory interface for reading and writing data to/from the memory 520. The results can be transmitted to another parallel processing unit 502 or CPU via the NVLink 516. In an embodiment, the parallel processing unit 502 includes a number U of memory partition unit 524 modules that is equal to the number of separate and distinct memory 520 devices coupled to the parallel processing unit 502. A memory partition unit 524 will be described in more detail below in conjunction with FIG. 7.

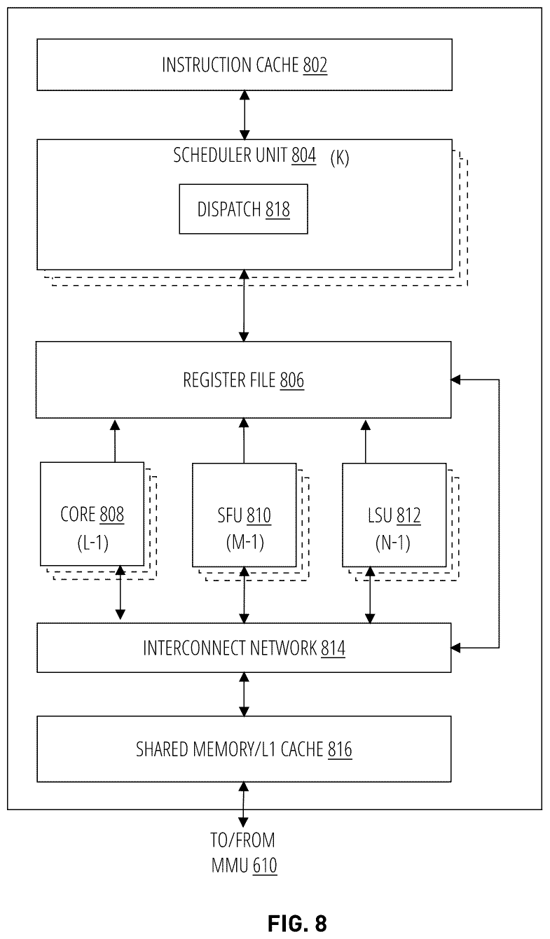

In an embodiment, a host processor executes a driver kernel that implements an application programming interface (API) that enables one or more applications executing on the host processor to schedule operations for execution on the parallel processing unit 502. In an embodiment, multiple compute applications are simultaneously executed by the parallel processing unit 502 and the parallel processing unit 502 provides isolation, quality of service (QoS), and independent address spaces for the multiple compute applications. An application may generate instructions (e.g., API calls) that cause the driver kernel to generate one or more tasks for execution by the parallel processing unit 502. The driver kernel outputs tasks to one or more streams being processed by the parallel processing unit 502. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 8.

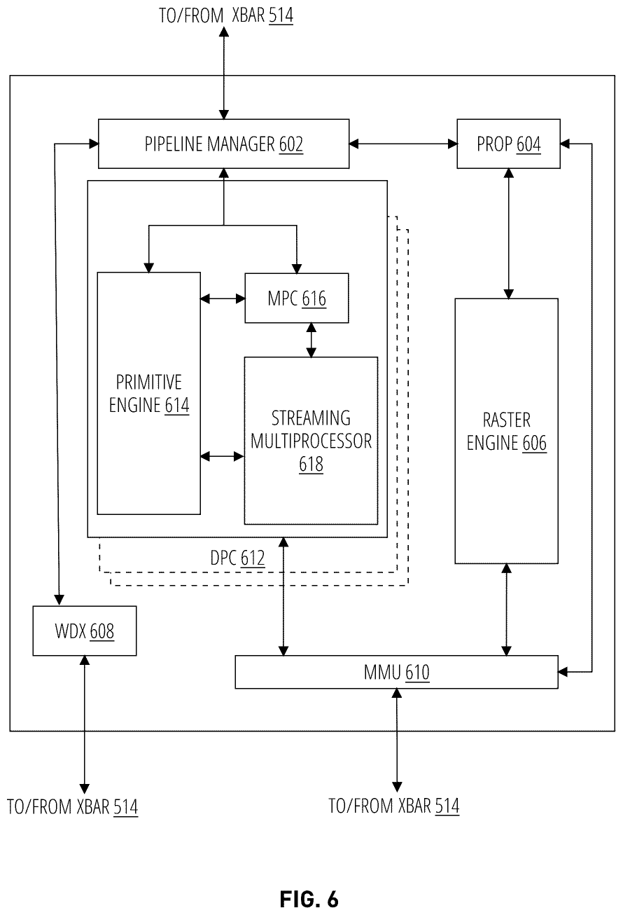

FIG. 6 depicts a general processing cluster 522 of the parallel processing unit 502 of FIG. 5, in accordance with an embodiment. As shown in FIG. 6, each general processing cluster 522 includes a number of hardware units for processing tasks. In an embodiment, each general processing cluster 522 includes a pipeline manager 602, a pre-raster operations unit 604, a raster engine 606, a work distribution crossbar 608, a memory management unit 610, and one or more data processing cluster 612. It will be appreciated that the general processing cluster 522 of FIG. 6 may include other hardware units in lieu of or in addition to the units shown in FIG. 6.

In an embodiment, the operation of the general processing cluster 522 is controlled by the pipeline manager 602. The pipeline manager 602 manages the configuration of the one or more data processing cluster 612 modules for processing tasks allocated to the general processing cluster 522. In an embodiment, the pipeline manager 602 may configure at least one of the one or more data processing cluster 612 modules to implement at least a portion of a graphics rendering pipeline. For example, a data processing cluster 612 may be configured to execute a vertex shader program on the programmable streaming multiprocessor 618. The pipeline manager 602 may also be configured to route packets received from the work distribution unit 510 to the appropriate logical units within the general processing cluster 522. For example, some packets may be routed to fixed function hardware units in the pre- raster operations unit 604 and/or raster engine 606 while other packets may be routed to the data processing cluster 612 modules for processing by the primitive engine 614 or the streaming multiprocessor 618. In an embodiment, the pipeline manager 602 may configure at least one of the one or more data processing cluster 612 modules to implement a neural network model and/or a computing pipeline.

The pre-raster operations unit 604 is configured to route data generated by the raster engine 606 and the data processing cluster 612 modules to a Raster Operations (ROP) unit, described in more detail in conjunction with FIG. 7. The pre-raster operations unit 604 may also be configured to perform optimizations for color blending, organize pixel data, perform address translations, and the like.

The raster engine 606 includes a number of fixed function hardware units configured to perform various raster operations. In an embodiment, the raster engine 606 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 606 comprises fragments to be processed, for example, by a fragment shader implemented within a data processing cluster 612.

Each data processing cluster 612 included in the general processing cluster 522 includes an M-pipe controller 616, a primitive engine 614, and one or more streaming multiprocessor 618 modules. The M-pipe controller 616 controls the operation of the data processing cluster 612, routing packets received from the pipeline manager 602 to the appropriate units in the data processing cluster 612. For example, packets associated with a vertex may be routed to the primitive engine 614, which is configured to fetch vertex attributes associated with the vertex from the memory 520. In contrast, packets associated with a shader program may be transmitted to the streaming multiprocessor 618.

The streaming multiprocessor 618 comprises a programmable streaming processor that is configured to process tasks represented by a number of threads. Each streaming multiprocessor 618 is multi-threaded and configured to execute a plurality of threads (e.g., 32 threads) from a particular group of threads concurrently. In an embodiment, the streaming multiprocessor 618 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 618 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 618 will be described in more detail below in conjunction with FIG. 8.

The memory management unit 610 provides an interface between the general processing cluster 522 and the memory partition unit 524. The memory management unit 610 may provide translation of virtual addresses into physical addresses, memory protection, and arbitration of memory requests. In an embodiment, the memory management unit 610 provides one or more translation lookaside buffers (TLBs) for performing translation of virtual addresses into physical addresses in the memory 520.

FIG. 7 depicts a memory partition unit 524 of the parallel processing unit 502 of FIG. 5, in accordance with an embodiment. As shown in FIG. 7, the memory partition unit 524 includes a raster operations unit 702, a level two cache 704, and a memory interface 706. The memory interface 706 is coupled to the memory 520. Memory interface 706 may implement 32, 64, 128, 1024-bit data buses, or the like, for high-speed data transfer. In an embodiment, the parallel processing unit 502 incorporates U memory interface 706 modules, one memory interface 706 per pair of memory partition unit 524 modules, where each pair of memory partition unit 524 modules is connected to a corresponding memory 520 device. For example, parallel processing unit 502 may be connected to up to Y memory 520 devices, such as high bandwidth memory stacks or graphics double-data-rate, version 5, synchronous dynamic random access memory, or other types of persistent storage.

In an embodiment, the memory interface 706 implements an HBM2 memory interface and Y equals half U. In an embodiment, the HBM2 memory stacks are located on the same physical package as the parallel processing unit 502, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 520 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 502 modules process very large datasets and/or run applications for extended periods.

In an embodiment, the parallel processing unit 502 implements a multi-level memory hierarchy. In an embodiment, the memory partition unit 524 supports a unified memory to provide a single unified virtual address space for CPU and parallel processing unit 502 memory, enabling data sharing between virtual memory systems. In an embodiment the frequency of accesses by a parallel processing unit 502 to memory located on other processors is traced to ensure that memory pages are moved to the physical memory of the parallel processing unit 502 that is accessing the pages more frequently. In an embodiment, the NVLink 516 supports address translation services allowing the parallel processing unit 502 to directly access a CPU's page tables and providing full access to CPU memory by the parallel processing unit 502.

In an embodiment, copy engines transfer data between multiple parallel processing unit 502 modules or between parallel processing unit 502 modules and CPUs. The copy engines can generate page faults for addresses that are not mapped into the page tables. The memory partition unit 524 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 520 or other system memory may be fetched by the memory partition unit 524 and stored in the level two cache 704, which is located on-chip and is shared between the various general processing cluster 522 modules. As shown, each memory partition unit 524 includes a portion of the level two cache 704 associated with a corresponding memory 520 device. Lower level caches may then be implemented in various units within the general processing cluster 522 modules. For example, each of the streaming multiprocessor 618 modules may implement an L1 cache. The L1 cache is private memory that is dedicated to a particular streaming multiprocessor 618. Data from the level two cache 704 may be fetched and stored in each of the L1 caches for processing in the functional units of the streaming multiprocessor 618 modules. The level two cache 704 is coupled to the memory interface 706 and the crossbar 514.

The raster operations unit 702 performs graphics raster operations related to pixel color, such as color compression, pixel blending, and the like. The raster operations unit 702 also implements depth testing in conjunction with the raster engine 606, receiving a depth for a sample location associated with a pixel fragment from the culling engine of the raster engine 606. The depth is tested against a corresponding depth in a depth buffer for a sample location associated with the fragment. If the fragment passes the depth test for the sample location, then the raster operations unit 702 updates the depth buffer and transmits a result of the depth test to the raster engine 606. It will be appreciated that the number of partition memory partition unit 524 modules may be different than the number of general processing cluster 522 modules and, therefore, each raster operations unit 702 may be coupled to each of the general processing cluster 522 modules. The raster operations unit 702 tracks packets received from the different general processing cluster 522 modules and determines which general processing cluster 1 that a result generated by the raster operations unit 702 is routed to through the crossbar 514. Although the raster operations unit 702 is included within the memory partition unit 524 in FIG. 7, in other embodiment, the raster operations unit 702 may be outside of the memory partition unit 524. For example, the raster operations unit 702 may reside in the general processing cluster 522 or another unit.

FIG. 8 illustrates the streaming multiprocessor 618 of FIG. 6, in accordance with an embodiment. As shown in FIG. 8, the streaming multiprocessor 618 includes an instruction cache 802, one or more scheduler unit 804 modules (e.g., such as scheduler unit 508), a register file 806, one or more processing core 808 modules, one or more special function unit 810 modules, one or more load/store unit 812 modules, an interconnect network 814, and a shared memory/L1 cache 816.

As described above, the work distribution unit 510 dispatches tasks for execution on the general processing cluster 522 modules of the parallel processing unit 502. The tasks are allocated to a particular data processing cluster 612 within a general processing cluster 522 and, if the task is associated with a shader program, the task may be allocated to a streaming multiprocessor 618. The scheduler unit 508 receives the tasks from the work distribution unit 510 and manages instruction scheduling for one or more thread blocks assigned to the streaming multiprocessor 618. The scheduler unit 804 schedules thread blocks for execution as warps of parallel threads, where each thread block is allocated at least one warp. In an embodiment, each warp executes 32 threads. The scheduler unit 804 may manage a plurality of different thread blocks, allocating the warps to the different thread blocks and then dispatching instructions from the plurality of different cooperative groups to the various functional units (e.g., core 808 modules, special function unit 810 modules, and load/store unit 812 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads() function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 818 unit is configured within the scheduler unit 804 to transmit instructions to one or more of the functional units. In one embodiment, the scheduler unit 804 includes two dispatch 818 units that enable two different instructions from the same warp to be dispatched during each clock cycle. In alternative embodiments, each scheduler unit 804 may include a single dispatch 818 unit or additional dispatch 818 units.

Each streaming multiprocessor 618 includes a register file 806 that provides a set of registers for the functional units of the streaming multiprocessor 618. In an embodiment, the register file 806 is divided between each of the functional units such that each functional unit is allocated a dedicated portion of the register file 806. In another embodiment, the register file 806 is divided between the different warps being executed by the streaming multiprocessor 618. The register file 806 provides temporary storage for operands connected to the data paths of the functional units.

Each streaming multiprocessor 618 comprises L processing core 808 modules. In an embodiment, the streaming multiprocessor 618 includes a large number (e.g., 128, etc.) of distinct processing core 808 modules. Each core 808 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 808 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 808 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A‘B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 618 also comprises M special function unit 810 modules that perform special functions (e.g., attribute evaluation, reciprocal square root, and the like). In an embodiment, the special function unit 810 modules may include a tree traversal unit configured to traverse a hierarchical tree data structure. In an embodiment, the special function unit 810 modules may include texture unit configured to perform texture map filtering operations. In an embodiment, the texture units are configured to load texture maps (e.g., a 2D array of texels) from the memory 520 and sample the texture maps to produce sampled texture values for use in shader programs executed by the streaming multiprocessor 618. In an embodiment, the texture maps are stored in the shared memory/L1 cache 816. The texture units implement texture operations such as filtering operations using mip-maps (e.g., texture maps of varying levels of detail). In an embodiment, each streaming multiprocessor 618 includes two texture units.

Each streaming multiprocessor 618 also comprises N load/store unit 812 modules that implement load and store operations between the shared memory/L1 cache 816 and the register file 806. Each streaming multiprocessor 618 includes an interconnect network 814 that connects each of the functional units to the register file 806 and the load/store unit 812 to the register file 806 and shared memory/L1 cache 816. In an embodiment, the interconnect network 814 is a crossbar that can be configured to connect any of the functional units to any of the registers in the register file 806 and connect the load/store unit 812 modules to the register file 806 and memory locations in shared memory/L1 cache 816.

The shared memory/L1 cache 816 is an array of on-chip memory that allows for data storage and communication between the streaming multiprocessor 618 and the primitive engine 614 and between threads in the streaming multiprocessor 618. In an embodiment, the shared memory/L1 cache 816 comprises 128 KB of storage capacity and is in the path from the streaming multiprocessor 618 to the memory partition unit 524. The shared memory/L1 cache 816 can be used to cache reads and writes. One or more of the shared memory/L1 cache 816, level two cache 704, and memory 520 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 816 enables the shared memory/L1 cache 816 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 510 assigns and distributes blocks of threads directly to the data processing cluster 612 modules. The threads in a block execute the same program, using a unique thread ID in the calculation to ensure each thread generates unique results, using the streaming multiprocessor 618 to execute the program and perform calculations, shared memory/L1 cache 816 to communicate between threads, and the load/store unit 812 to read and write global memory through the shared memory/L1 cache 816 and the memory partition unit 524. When configured for general purpose parallel computation, the streaming multiprocessor 618 can also write commands that the scheduler unit 508 can use to launch new work on the data processing cluster 612 modules.

The parallel processing unit 502 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 502 is embodied on a single semiconductor substrate. In another embodiment, the parallel processing unit 502 is included in a system-on-a-chip (SoC) along with one or more other devices such as additional parallel processing unit 502 modules, the memory 520, a reduced instruction set computer (RISC) CPU, a memory management unit (MMU), a digital-to-analog converter (DAC), and the like.

In an embodiment, the parallel processing unit 502 may be included on a graphics card that includes one or more memory devices. The graphics card may be configured to interface with a PCIe slot on a motherboard of a desktop computer. In yet another embodiment, the parallel processing unit 502 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 9 is a conceptual diagram of a processing system implemented using the parallel processing unit 502 of FIG. 5, in accordance with an embodiment. The processing system includes a central processing unit 902, an switch 904, and multiple parallel processing unit 502 modules each and respective memory 520 modules. The switch 904 is depicted with dashed lines, indicating that it is optional in some embodiments.

The NVLink 516 provides high-speed communication links between each of the parallel processing unit 502 modules. Although a particular number of NVLink 516 and interconnect 518 connections are illustrated in FIG. 9, the number of connections to each parallel processing unit 502 and the central processing unit 902 may vary. The switch 904 interfaces between the interconnect 518 and the central processing unit 902. The parallel processing unit 502 modules, memory 520 modules, and NVLink 516 connections may be situated on a single semiconductor platform to form a parallel processing module 906. In an embodiment, the switch 904 supports two or more protocols to interface between various different connections and/or links.

In another embodiment (not shown), the NVLink 516 provides one or more high-speed communication links between each of the parallel processing unit modules (parallel processing unit 502, parallel processing unit 502, parallel processing unit 502, and parallel processing unit 502) and the central processing unit 902 and the switch 904 (when present) interfaces between the interconnect 518 and each of the parallel processing unit modules. The parallel processing unit modules, memory 520 modules, and interconnect 518 may be situated on a single semiconductor platform to form a parallel processing module 906. In yet another embodiment (not shown), the interconnect 518 provides one or more communication links between each of the parallel processing unit modules and the central processing unit 902 and the switch 904 interfaces between each of the parallel processing unit modules using the NVLink 516 to provide one or more high-speed communication links between the parallel processing unit modules. In another embodiment (not shown), the NVLink 516 provides one or more high-speed communication links between the parallel processing unit modules and the central processing unit 902 through the switch 904. In yet another embodiment (not shown), the interconnect 518 provides one or more communication links between each of the parallel processing unit modules directly. One or more of the NVLink 516 high-speed communication links may be implemented as a physical NVLink interconnect or either an on-chip or on-die interconnect using the same protocol as the NVLink 516.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 906 may be implemented as a circuit board substrate and each of the parallel processing unit modules and/or memory 520 modules may be packaged devices. In an embodiment, the central processing unit 902, switch 904, and the parallel processing module 906 are situated on a single semiconductor platform.

In an embodiment, each parallel processing unit module includes six NVLink 516 interfaces (as shown in FIG. 9, five NVLink 516 interfaces are included for each parallel processing unit module). The NVLink 516 may be operated exclusively for PPU-to-PPU communication as shown in FIG. 9, or some combination of PPU-to-PPU and PPU-to-CPU, when the central processing unit 902 also includes one or more NVLink 516 interfaces.

In an embodiment, the NVLink 516 allows direct load/store/atomic access from the central processing unit 902 to each parallel processing unit module's memory 520. In an embodiment, the NVLink 516 supports coherency operations, allowing data read from the memory 520 modules to be stored in the cache hierarchy of the central processing unit 902, reducing cache access latency for the central processing unit 902. In an embodiment, the NVLink 516 includes support for Address Translation Services (ATS), enabling the parallel processing unit module to directly access page tables within the central processing unit 902. One or more of the NVLink 516 may also be configured to operate in a low-power mode.

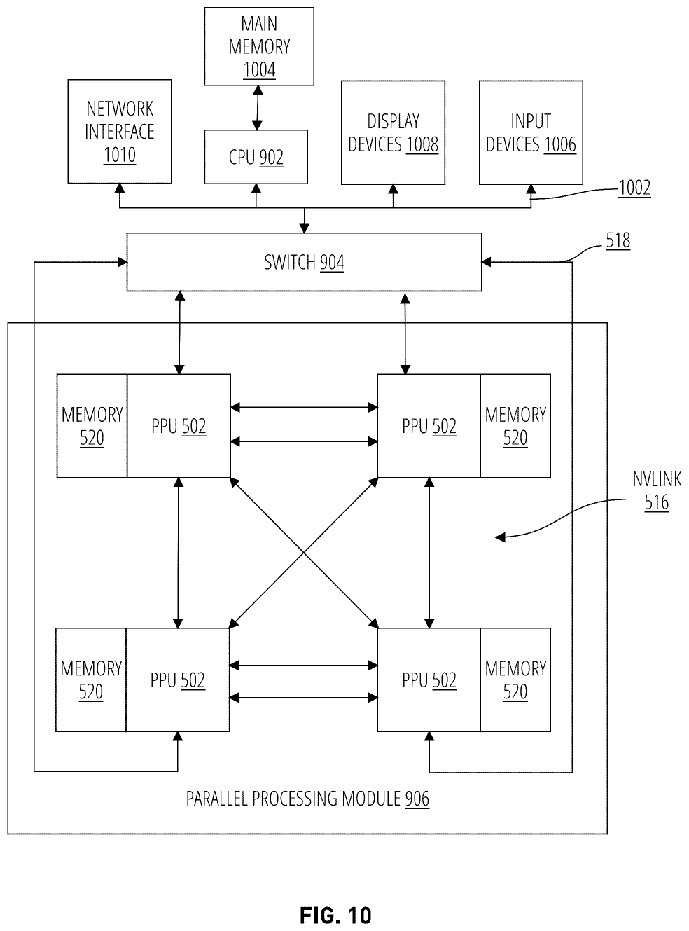

FIG. 10 depicts an exemplary processing system in which the various architecture and/or functionality of the various previous embodiments may be implemented. As shown, an exemplary processing system is provided including at least one central processing unit 902 that is connected to a communications bus 1002. The communication communications bus 1002 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1004. Control logic (software) and data are stored in the main memory 1004 which may take the form of random access memory (RAM). For simplicity of illustration, the main memory 1004 may be understood to comprise other forms of bulk memory, including non-volatile memory technologies.

The exemplary processing system also includes input devices 1006, the parallel processing module 906, and display devices 1008, e.g. a conventional CRT (cathode ray tube), LCD (liquid crystal display), LED (light emitting diode), plasma display or the like. User input may be received from the input devices 1006, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1010 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1004 and/or the secondary storage. Such computer programs, when executed, enable the exemplary processing system to perform various functions. The main memory 1004, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart- phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 encoder
104 causal 3D convolution block
106 causal 3D residual block
108 spatio-temporal downsampling block
110 causal 3D residual block
112 spatio-temporal attention block
114 spatio-temporal downsampling block
116 causal 3D residual block
118 latent space embedding component
120 causal 3D residual block
122 spatio-temporal attention block
124 causal 3D residual block
126 Gaussian sampling block
128 causal 3D residual block
130 spatio-temporal attention block
132 causal 3D residual block
134 decoder
136 causal 3D residual block
138 causal 3D residual block
140 causal 3D residual block
142 spatio-temporal attention block
144 causal 3D convolution block
146 spatio-temporal upsampling block
148 spatio-temporal upsampling block
202 concatenator
302 group normalization and Swish activation layer(s)
304 causal 3D convolution layer(s)
306 group normalization and Swish activation layer(s)
308 causal 3D convolution layer(s)
310 self-attention layer
312 causal attention layer
314 causal 3D convolution layer
316 3D average pooling layer
318 causal 3D convolution layer
320 causal 3D transpose convolution layer
322 interpolation upsampling layer
324 causal 3D convolution layer
502 parallel processing unit
504 I/O unit
506 front-end unit
508 scheduler unit
510 work distribution unit
512 hub
514 crossbar
516 NVLink
518 interconnect
520 memory
522 general processing cluster
524 memory partition unit
602 pipeline manager
604 pre-raster operations unit
606 raster engine
608 work distribution crossbar
610 memory management unit
612 data processing cluster
614 primitive engine
616 M-pipe controller
618 streaming multiprocessor
702 raster operations unit
704 level two cache
706 memory interface
802 instruction cache
804 scheduler unit
806 register file
808 core
810 special function unit
812 load/store unit
814 interconnect network
816 shared memory/L1 cache
818 dispatch
902 central processing unit
904 switch
906 parallel processing module
1002 communications bus
1004 main memory
1006 input devices
1008 display devices
1010 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory, and firmware are examples of logic. Logic specifically excludes pure signals or software per se (however does not exclude non-transitory machine memories comprising software and thereby forming statutory configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A video compression system comprising a variational autoencoder, the variational autoencoder comprising:
an encoder and a decoder coupled via a latent space embedding component;
the encoder configured to transform an input video into a plurality of feature maps of the input video at different feature resolution scales;
the latent space embedding component configured to transform the feature maps into a latent space parameter distribution; and
the decoder configured to sample the latent space parameter distribution to generate a compressed version of the input video.

2. The video compression system of claim 1, wherein the latent space parameter distribution comprises a lower dimensionality than a dimensionality of the feature maps.

3. The video compression system of claim 1, wherein the latent space parameter distribution comprises an approximately Gaussian distribution.

4. The video compression system of claim 1, wherein the decoder is configured to transform points in the latent space parameter distribution back into a feature space of the input video.

5. The video compression system of claim 1, wherein the variational autoencoder is configured with a loss function that combines reconstruction loss and regularization loss during training.

6. The video compression system of claim 1, wherein the variational autoencoder comprises temporally-causal three-dimensional (3D) convolution layers interleaved with self-attention layers.

7. The video compression system of claim 1, further comprising a plurality of weight-shared encoders each configured to generate feature maps of the input video at different dimensional scales.

8. The video compression system of claim 1, further comprising a dual-path spatio-temporal downsampler utilizing both learnable and non-learnable kernels.

9. The video compression system of claim 1, the variational autoencoder configured to apply a flow regularization loss during training.

10. The video compression system of claim 9, the variational autoencoder configured to optimize a mean-squared error between optical flows of the input video frames and corresponding optical flows in decoded video frames of the input video.

11. The video compression system of claim 1, the variational autoencoder configured to apply a perceptual loss during training.

12. The video compression system of claim 1, the variational autoencoder configured to apply a reconstruction loss during training.

13. The video compression system of claim 1, each encoder comprising a plurality of causal 3D residual blocks.

14. The video compression system of claim 1, each encoder comprising a plurality of spatio-temporal downsampling blocks.

15. The video compression system of claim 1, each encoder comprising a causal 3D convolution block.

16. The video compression system of claim 1, each encoder comprising a spatio-temporal attention block.

17. The video compression system of claim 1, the latent space embedding component comprising a plurality of causal 3D residual blocks.

18. The video compression system of claim 1, the latent space embedding component comprising a plurality of spatio-temporal attention blocks.

19. The video compression system of claim 1, the latent space embedding component comprising a Gaussian sampling block.

20. The video compression system of claim 1, the decoder comprising a plurality of causal 3D residual blocks.

21. The video compression system of claim 1, the decoder comprising a spatio-temporal attention block.

22. The video compression system of claim 1, the decoder comprising a causal 3D convolution block.

23. The video compression system of claim 1, the decoder comprising a plurality of spatio-temporal upsampling blocks.

24. The video compression system of claim 1, wherein the encoder, latent space embedding component, and decoder each comprise at least one causal 3D residual block.

25. The video compression system of claim 24, wherein each causal 3D residual block comprises a group normalization layer.

26. The video compression system of claim 24, wherein each causal 3D residual block comprises a Swish activation layer.

27. The video compression system of claim 24, wherein each causal 3D residual block comprises a causal 3D convolution layer.

28. The video compression system of claim 1, wherein the encoder, latent space embedding component, and decoder each comprise at least one causal 3D attention block.

29. The video compression system of claim 1, each spatio-temporal attention block comprising a self-attention layer and a causal attention layer.

30. The video compression system of claim 1, the encoder comprising a plurality of spatio-temporal downsampling blocks.

31. The video compression system of claim 30, each spatio-temporal downsampling block comprising comprising a 3D average pooling layer configured in parallel with a first causal 3D convolution layer.

32. The video compression system of claim 31, each spatio-temporal downsampling block configured to supply a sum of outputs of the first causal 3D convolution layer and the 3D average pooling layer to a second causal 3D convolution layer.

33. The video compression system of claim 1, the decoder comprising at least one spatio-temporal upsampling block.

34. The video compression system of claim 33, each spatio-temporal upsampling block comprising a causal 3D transpose convolution layer configured in parallel with an interpolation upsampling layer.

35. The video compression system of claim 34, each spatio-temporal upsampling block configured to supply a sum of outputs of the interpolation upsampling layer and the causal 3D transpose convolution layer to a causal 3D convolution layer.

36. A computer system comprising:
a memory configured with machine-readable instructions;
one or more data processor; and
wherein the instructions, when applied to the one or more data processors, configure the computer system to form:
an encoder and a decoder coupled via a latent space embedding component;
the encoder configured to transform an input video into a plurality of feature maps of the input video at different feature resolution scales;
the latent space embedding component configured to transform the feature maps into a latent space parameter distribution; and
the decoder configured to sample the latent space parameter distribution to generate a compressed version of the input video.

37. A non-volatile machine-readable medium comprising instructions that, when applied to one or more data processors of a computer system, configure the computer system to:
form an encoder and a decoder coupled via a latent space embedding component;
the encoder configured to transform an input video into a plurality of feature maps of the input video at different feature resolution scales;
the latent space embedding component configured to transform the feature maps into a latent space parameter distribution; and
the decoder configured to sample the latent space parameter distribution to generate a compressed version of the input video.
